(19) United States
(12) Patent Application Publication
(10) Pub. No.: US 2024/0190238 A1
(43) Pub. Date: Jun. 13, 2024

(54) DRIVE DEVICE FOR A VEHICLE WHEEL

(71) Applicant: Süddeutsche Gelenkscheibenfabrik GmbH & Co. KG, Waldkraiburg (DE)

(72) Inventor: Armin Huber, Schönberg (DE)

(73) Assignee: Süddeutsche Gelenkscheibenfabrik GmbH & Co. KG, Waldkraiburg (DE)

(21) Appl. No.: 18/532,879

(22) Filed: Dec. 7, 2023

(30) Foreign Application Priority Data
Dec. 7, 2022 (DE) 10 2022 132 579.2

(51) Int. Cl. B60K 7/00; B60K 17/04

(52) U.S. Cl. CPC B60K 7/0007; B60K 17/043

(57) ABSTRACT

A drive device for a vehicle wheel is provided, wherein the drive device is configured to be fastened to a vehicle body or vehicle frame close to the wheel, wherein the drive device has at least one drive and at least one torque transmission device, wherein the torque transmission device is configured to decouple the at least one drive from the at least one vehicle wheel, wherein the at least one torque transmission device has at least one joint device.

### FIELD OF THE INVENTION

The present invention relates to a drive device for a vehicle wheel. The present invention further relates to a wheel suspension or a vehicle axle comprising at least one such drive device. In addition, the present invention relates to a vehicle, in particular a road vehicle, comprising such a drive device.

### BACKGROUND OF THE INVENTION

Drive devices for a vehicle wheel are known from the prior art. Such known drive devices are often configured as a wheel hub motor sitting directly on the wheel hub or being directly connected to the wheel hub. Such drive devices comprising a wheel hub motor are known, for example, from documents DE 10 2021 200 315 A1 and DE 10 2021 230 355 A1. DE 10 2021 230 355 A1 discloses a vehicle wheel into which a wheel hub motor is integrated. The wheel hub motor comprises a transmission and an electric machine in the form of an electric motor. DE 10 2021 200 315 A1 contains a similar disclosure.

### BRIEF SUMMARY OF THE INVENTION

It is an object of the present invention to provide a drive device for a vehicle wheel that helps to reduce the unsprung masses on a vehicle wheel with a simple design.

This object is achieved with a drive device for a vehicle wheel having the features of the drive device being configured to be fastened to a vehicle body or a vehicle frame close to the wheel, wherein the drive device has at least one drive and at least one torque transmission device, wherein the torque transmission device is configured to decouple the at least one drive from the at least one vehicle wheel, wherein the at least one torque transmission device has at least one joint device. In one embodiment, the torque transmission device has at least one shaft coupled to the at least one joint device. In another embodiment, the torque transmission device has at least one first joint device and at least one second joint device that are coupled to the at least one shaft. In another embodiment, the at least one drive is arranged coaxially with the axis of rotation of the vehicle wheel. In another embodiment, the at least one shaft is a hollow shaft. In another embodiment, the at least one drive is arranged coaxially with the at least one shaft. In another embodiment, the at least one drive is arranged in a radial direction with an offset from the axis of rotation of the vehicle wheel. In another embodiment, the drive device comprises a plurality of drives that are arranged in a radial direction with an offset from the axis of rotation of the vehicle wheel. In another embodiment, the axis of rotation of the drive extends substantially parallel to the axis of rotation of the vehicle wheel. In another embodiment, the drive device has at least one transmission. In another embodiment, the drive is coupled to the at least one transmission via the at least one shaft and the at least one joint device. In another embodiment, the at least one transmission is arranged on the at least one drive. In another embodiment, the at least one transmission, at least in sections, is arranged in an axial direction with an offset from the at least one drive. In another embodiment, the at least one joint device couples the at least one drive to the vehicle wheel directly and without a transmission in a torque-transmitting manner. In another embodiment, the at least one drive is attached directly to the vehicle body or the vehicle frame via an elastic fastening device. In another embodiment, the at least one hollow shaft comprises two flange portions, wherein the first joint device and the second joint device are arranged on the axial outer surfaces of the flange portions. In another embodiment, the hollow shaft extends radially around the outside of the drive or through the drive. In another embodiment, the at least one joint device is configured as a thread-reinforced joint device. In another embodiment, the at least one joint device comprises at least one thread package, at least two bushings and at least one elastic body into which the at least one thread package is embedded. In another embodiment, the at least on joint device is configured as a wedge package coupling or as a curved-tooth coupling. In another embodiment, the at least one torque transmission device is configured such that the at least one torque transmission device is arranged between the at least one drive and the at least one transmission or between the at least one drive and the vehicle wheel. In another embodiment, the torque transmission device is arranged between the at least one drive and the vehicle wheel. In another embodiment, the at least one drive is an electric motor. In another embodiment, the vehicle wheel is a wheel of an electric road vehicle.

This object is also achieved with a drive device for a vehicle wheel wherein the drive device is configured to be fastened to a vehicle body or vehicle frame close to the wheel, wherein the drive device has at least one drive and at least one joint device, wherein the at least one joint device is configured to directly couple the at least one drive to the at least one vehicle wheel. In one embodiment, the at least one drive is an electric motor. In another embodiment, the vehicle wheel is a wheel of an electric road vehicle.

This object is also achieved by a vehicle axle or independent wheel suspension for an electric vehicle, comprising a drive device being configured to be fastened to a vehicle body or a vehicle frame close to the wheel, wherein the drive device has at least one drive and at least one torque transmission device, wherein the torque transmission device is configured to decouple the at least one drive from the at least one vehicle wheel, wherein the at least one torque transmission device has at least one joint device. In another embodiment, the vehicle axle or independent wheel suspension for an electric vehicle, comprises a drive device for a vehicle wheel wherein the drive device is configured to be fastened to a vehicle body or vehicle frame close to the wheel, wherein the drive device has at least one drive and at least one joint device, wherein the at least one joint device is configured to directly couple the at least one drive to the at least one vehicle wheel.

This object is also achieved by an electric road vehicle, comprising at least one drive device being configured to be fastened to a vehicle body or a vehicle frame close to the wheel, wherein the drive device has at least one drive and at least one torque transmission device, wherein the torque transmission device is configured to decouple the at least one drive from the at least one vehicle wheel, wherein the at least one torque transmission device has at least one joint device. In another embodiment, the electric road vehicle, comprises at least one drive device for a vehicle wheel wherein the drive device is configured to be fastened to a vehicle body or vehicle frame close to the wheel, wherein the drive device has at least one drive and at least one joint device, wherein the at least one joint device is configured to directly couple the at least one drive to the at least one vehicle wheel.

The present invention relates to a drive device for a vehicle wheel. The drive device is configured to be fastened to a vehicle body close to the wheel. The drive device has at least one drive and at least one torque transmission device. The at least one torque transmission device is configured to decouple at least the at least one drive from the at least one vehicle wheel, wherein the at least one torque transmission device has at least one joint device.

Using the drive device according to the invention, the unsprung masses on a vehicle wheel can be reduced since the at least one drive can be attached to the vehicle body or the vehicle frame such that is decoupled from the vehicle wheel. In this context, a vehicle frame is also to be understood as a subframe of a vehicle. In terms of suspension, the at least one drive is at least partially decoupled from the vehicle wheel. Such decoupling is achieved through the at least one torque transmission device comprising the at least one joint device. The at least one torque transmission device is arranged between the drive and the vehicle wheel. As a result, the drive is at least no longer part of the unsprung mass on the vehicle wheel, or only makes up a portion of it.

Due to the design of the drive device, it is not a wheel hub motor since the drive device can be connected to the vehicle wheel independently of the wheel hub. The at least one drive is neither directly connected to the wheel hub nor seated on the wheel hub. This means that although the at least one drive is arranged close to the wheel, it is not a wheel hub motor.

The at least one drive may be attached directly to the vehicle body or to the vehicle frame. The at least one drive may be connected to the vehicle wheel independently of a wheel suspension or an axle of the vehicle. The at least one drive may further be attached to the vehicle body independently of the at least one wheel suspension or an axle of the vehicle.

The at least one torque transmission device may comprise at least one shaft. The at least one shaft may be coupled to the at least one joint device.

The at least one torque transmission device may comprise a first joint device and a second joint device. The first joint device and the second joint device may be coupled to the at least one shaft. At each end of the at least one shaft, one of the joint devices may be arranged.

The at least one drive may be arranged coaxially with the vehicle wheel's axis of rotation. For example, the at least one drive may radially surround the vehicle wheel's axis of rotation on the outside. The at least one drive may further radially surround parts or portions of a wheel suspension or an axle of the vehicle.

The at least one shaft may be a hollow shaft. The at least one hollow shaft allows various components of the drive device to be arranged one inside the other in a radial direction. In this way, axial installation space can be saved. For example, the drive can be arranged radially within the hollow shaft. Similarly, at least one shaft or hollow shaft may extend through the at least one drive. For this purpose, the at least one drive may have an opening.

The hollow shaft may have base. The at least one drive may be arranged within the hollow shaft. The base of the hollow shaft may be connected to the at least one joint device. The hollow shaft may extend radially around the outside of at least parts or portions of a wheel suspension or an axle of the vehicle.

The at least one drive may be arranged coaxially with the at least one shaft. The axis of rotation of the at least one drive may coincide with the central axis of the at least one shaft.

The at least one drive may be arranged in a radial direction with an offset from the vehicle wheel's axis of rotation. The drive's axis of rotation may be arranged in a radial direction with an offset from the vehicle wheel's axis of rotation. The drive's axis of rotation may extend substantially parallel to the vehicle wheel's axis of rotation. The at least one drive may be arranged in a radial direction with an offset from the central axis of the at least one shaft. The drive's axis of rotation may extend substantially parallel to the vehicle wheel's axis of rotation.

The drive device may comprise a plurality of drives. The drives may be arranged in a radial direction with an offset from the vehicle wheel's axis of rotation. The drives' axes of rotation may be arranged on one or more radii around the vehicle wheel's axis of rotation. The drives may be arranged in a radial, axial or tangential direction with an offset from the central axis of the at least one shaft.

The drive device may comprise at least one transmission. The at least one drive may be coupled to the at least one transmission via the at least one shaft and the at least one joint device. The at least one transmission may, at least in sections, be arranged in an axial direction with an offset from the at least one drive. If a plurality of drives are arranged, a transmission pinion gear can be assigned to each of the drives so that, depending on the respective driving situation of the vehicle, the drives can be engaged individually, in groups or collectively to drive the vehicle wheel.

The at least one transmission may be arranged on the at least one drive. The at least one transmission may be coupled directly to the at least one drive. The at least one transmission and the at least one drive may form a drive unit. The drive unit formed by the transmission and the drive may be coupled to the vehicle wheel in a torque-transmitting manner via the at least one torque transmission device.

The at least one transmission may be a planetary gear or a spur gear. The planetary gear may comprise a sun gear, planet gears, a ring gear and a carrier member for the planet gears. The sun gear may be coupled to the drive, driving the planet gears. The ring gear may be connected to the vehicle body or the vehicle frame. The planet gears may drive the carrier member coupled to the at least one torque transmission device.

The torque transmission device may couple at least one drive to the vehicle wheel. This allows the drive to be decoupled from the vehicle wheel in terms of suspension. The torque transmission device may further couple the drive unit formed by the at least one drive and the at least one transmission to the vehicle wheel. In this case, the at least one torque transmission device may decouple the drive unit formed by the at least one drive and the at least one transmission from the vehicle wheel in terms of suspension. Here, not only the motor but also the transmission is no longer or only proportionally part of the unsprung mass on the vehicle wheel.

The at least one transmission may be coupled to the vehicle wheel. The at least one drive may be supported on the wheel suspension or an axle of the vehicle. The at least one torque transmission device may extend between the at least one drive and the at least one transmission. In this case, the drive can be decoupled in terms of suspension from the transmission, coupled to the vehicle wheel, and the vehicle wheel via the torque transmission device. In this case, the drive may be fastened to the vehicle body or the vehicle frame.

The at least one drive device may be configured as a gearless direct drive. The at least one joint device may couple the at least one drive to the vehicle wheel directly and without a transmission. The at least one drive may be attached directly to the vehicle body or the vehicle frame via an elastic fastening device. The elastic fastening device may be formed by a joint device. The fastening device may act as a torque support.

The hollow shaft may comprise at least one flange portion. The hollow shaft may comprise flange portions at its ends. The at least one hollow shaft may have two end faces facing away from each other. The first joint device may be arranged on one of the end faces, and the second joint device may be arranged on the other end face. The end faces may be the end faces of the flange portions.

The at least one hollow shaft may extend radially around the outside of the drive. The hollow shaft may extend radially inwards through the drive. The at least one drive may be arranged in a radial direction with an offset from the hollow shaft. The hollow shaft may surround parts or portions of a wheel suspension or an axle of the vehicle in a radial direction. The at least one hollow shaft may be arranged coaxially with parts or portions of the wheel suspension or an axle of the vehicle.

The at least one joint device may be configured as a thread-reinforced joint device. The thread-reinforced joint device may be configured to transmit torques. The at least one thread-reinforced joint device may have at least one tab-shaped thread package. The thread-reinforced joint device may further have a plurality of tab-shaped thread packages. The tab-shaped thread packages may be arranged to form a ring. The thread packages may, for example, be coupled to one another via at least one bushing.

The at least one thread-reinforced joint device may comprise a plurality of bushings arranged in a circumferential direction at predetermined angular distances relative a central axis of the thread-reinforced joint device, a plurality of thread packages, each thread package wrapping around at least two bushings, and at least one elastic body into which at least one thread package and the bushings are at least partially embedded.

The thread-reinforced joint device may have a support device that is arranged on at least one of the bushings to axially guide the thread packages. The support devices may be formed by at least two collar elements that may be attached to a bushing or integrally formed with the bushing.

The thread packages may be arranged in the elastic body in a circumferential direction with an offset from one another. A thread package may form a unit with the bushings wrapped by the thread package. Such unit may be offset in a circumferential direction relative to the other thread packages and the bushings wrapped by these thread packages. The other thread packages and the bushings wrapped by these thread packages, too, may each form a unit. The units formed by the thread packages and the bushings wrapped by these thread packages may be connected to one another via the at least one elastic connecting portion. In other words, the described units comprising at least one thread package and the bushings can be connected to one another via an elastic connecting portion made of an elastic material. A thread-reinforced joint device designed in this way forms a single component. Such a thread-reinforced joint device helps to save installation space in an axial direction and makes the thread-reinforced joint device easier to handle.

Each bushing may be wrapped by two or more thread packages, so that a ring of thread packages and bushings can be formed. This ring may be embedded into the at least one elastic body. Such thread-reinforced joint devices may also be referred to as a “joint disk”.

The drive device may be connected to the vehicle body or the vehicle frame via the at least one fastening device. The at least one fastening device may serve as a torque support. The at least one fastening device may have at least one thread-reinforced device. The thread-reinforced device may be configured to transmit tensile and/or compressive forces. The thread-reinforced device may have at least one thread-reinforced coupling member. The at least one thread-reinforced coupling member may comprise an elastic body into which at least one thread package and at least two bushings are embedded. The at least one thread package may wrap around the at least two bushings. The at least one thread-reinforced coupling member may be connected to the vehicle body or the vehicle frame and the drive device. For example, the at least one thread-reinforced coupling member may connect the motor or the transmission to the vehicle body or the vehicle frame. The at least one fastening device may further have at least one thread-reinforced joint device that may serve to fasten the drive device to the vehicle body or the vehicle frame.

The thread-reinforced joint device may comprise one thread-reinforced coupling member or a plurality of thread-reinforced coupling members. The thread-reinforced joint device may be composed of a plurality of separate thread-reinforced coupling members that are coupled to one another. In other words, a plurality of thread-reinforced coupling members may be connected to one another to form a thread-reinforced joint device. Such thread-reinforced joint device may be configured as a ring, for example. Bushings, for example, may be provided for coupling the thread-reinforced coupling members. A bushing may, for example, couple two thread-reinforced coupling members to one another.

The at least one elastic body may, for example, be made of an elastomer, a thermoplastic elastomer, a polymer, rubber or silicone. The at least one thread package may be made of threads wound individually to have the shape of a tab or of at least one single thread wound to have the shape of a tab.

The at least one drive may be elastically, i.e. in a decoupling manner, connected to the vehicle frame or the vehicle body. Alternatively, the at least one drive may be firmly connected to the vehicle frame or the vehicle body. Fastening the drive without decoupling is particularly suitable for fastening the drive to a vehicle frame.

The at least one joint device may be configured as a wedge package coupling or as a curved-tooth coupling.

The present invention further relates to a drive device for a vehicle wheel, wherein the drive device is configured to be fastened to a vehicle body or a vehicle frame close to the wheel, wherein the drive device has at least one drive and at least one elastic joint device, wherein the at least one joint device is configured to directly couple the at least one drive to the at least one vehicle wheel.

The at least one drive may be an electric driving machine, a hydraulic driving machine or a pneumatic driving machine. Accordingly, the at least one drive may have an electric motor or be configured as an electric motor. Together with a transmission, the electric motor may form a drive unit. The electric motor may be configured as an internal rotor motor or as an external rotor motor. The electric motor may have an opening in which further components of the drive device can be arranged or into which further components of the drive device can be integrated.

The vehicle wheel may be a wheel of a road vehicle, in particular an electric road vehicle.

The present invention further relates to a wheel suspension or a vehicle axle comprising at least one drive device of the type described above. The vehicle axle may be a rigid axle. Such a rigid axle may be configured as a portal axle. The present invention further relates to a vehicle comprising at least one drive device of the type described above.

The present invention relates to an electric vehicle comprising at least one drive device of the type described above. The present invention further relates to a road vehicle, in particular an electric road vehicle, comprising at least one drive device of the type described above.

### BRIEF DESCRIPTION OF THE SEVERAL VIEWS OF THE DRAWING

In the following, an example embodiment is described with reference to the accompanying figures. In the drawings:

FIG. 1 is a sectional view taken through a drive device arranged on a vehicle wheel according to a first embodiment;

FIG. 2 is a sectional view taken through a drive device arranged on a vehicle wheel according to a second embodiment;

FIG. 3 is a sectional view taken through a drive device arranged on a vehicle wheel according to a third embodiment;

FIG. 4 is a rear view of a drive device according to a fourth embodiment taken from the direction of the vehicle body;

FIG. 5 is a sectional view taken along section line V-V in FIG. 4;

FIG. 6 is a sectional view taken through a drive device arranged on a vehicle wheel according to a fifth embodiment;

FIG. 7 is a sectional view taken through a drive device arranged on a vehicle wheel according to a sixth embodiment;

FIG. 8 is a sectional view taken through a drive device arranged on a vehicle wheel according to a seventh embodiment;

FIG. 9 is a sectional view taken through a drive device arranged on a FIG. 9 vehicle wheel according to an eighth embodiment;

FIG. 10 is a sectional view taken through a drive device arranged on a vehicle wheel according to a ninth embodiment;

FIG. 11 is a sectional view taken through a drive device arranged on a vehicle wheel according to a tenth embodiment;

FIG. 12 is a sectional view taken through a drive device arranged on a vehicle wheel according to an eleventh embodiment;

FIG. 13 is a perspective view of a joint device according to one implementation;

FIG. 14 is a perspective view of a joint device according to another implementation;

FIG. 15 is a sectional view taken through a drive device arranged on a vehicle wheel according to a twelfth embodiment.

### DETAILED DESCRIPTION OF THE INVENTION

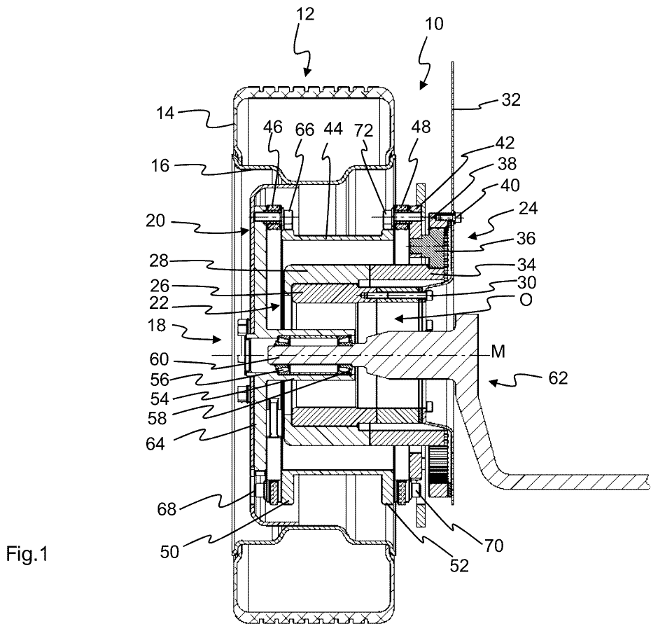

FIG. 1 is a sectional view of a drive device 10 for a vehicle wheel 12 (not shown) according to a first embodiment. Such drive device 10 for a vehicle wheel 12 may also be referred to as a single-wheel drive.

The vehicle wheel 12 has a tire 14 and a rim 16. The rim 16 is attached to a wheel hub 18. The fastening position of the drive device 10 may thus be described as close to the wheel. Since there is no direct connection to the wheel hub, the drive device is not a wheel hub motor.

The drive device 10 is attached to a vehicle body or a vehicle frame 32. The vehicle frame may also be a subframe of a vehicle. The drive device 10 has a torque transmission device 20 and a drive 22. The torque transmission device 20 has a transmission 24. According to the embodiments shown, the drive 22 is an electric motor 22. Alternatively, the drive 22 may be configured as a hydraulic or pneumatic driving machine (not shown). The electric motor 22 has a stator 26 and a rotor 28. The electric motor 22 is an external rotor motor. The stator 26 of the electric motor 22 is attached to the vehicle body or the vehicle frame 32 via screws 30. The rotor 26 of the electric motor 22 is coupled to the transmission 24.

The transmission 24 may be configured as a planetary gear. The transmission 24 has a sun gear 34, planet gears 36 and a ring gear 38. The ring gear 38 is attached to the vehicle body or the vehicle frame 40 via screws 40. Shims may be provided between the ring gear 38 and the vehicle body or the vehicle frame 32. Such shims may be, for example, washers on the screws 40 or similar elements. The shims can be elastic. The ring gear 38 has internal teeth the planet gears 36 are in engagement with. The planet gears 36 are rotatably mounted on a carrier member 42, driving the carrier member 42. The carrier member 42 transmits the torque to the torque transmission device 20 which is coupled to the vehicle wheel 12.

The torque transmission device 20 has a shaft 44. The shaft 44 is configured as a hollow shaft. The hollow shaft 44 extends between the rim 16 and the transmission 24. The torque transmission device 20 further comprises a first joint device 46 and a second joint device 48. The first joint device 46 and/or the second joint device 48 may each be configured as a thread-reinforced joint device. The first joint device 46 and/or the second joint device 48 may, for example, each be configured as an elastic joint disk or as an elastic ring of tabs. To connect to the first joint device 46 and the second joint device 48, the hollow shaft 44 has a flange portion 50 at one end and a flange portion 52 at the other end. The flange portions 50 and 52 extend outwards in a radial direction.

The wheel hub 18 has a tube portion 54 accommodating wheel bearings 56 and 58. The wheel hub 18 is rotatably mounted on a rigid axle portion 60 of a rigid axle 62 via the wheel bearings 56 and 58. According to the embodiment shown, the rigid axle 62 is configured as a portal axle.

A connecting member 64 establishes a connection between the drive device 10, attached to the vehicle body or the vehicle frame 32, and the vehicle wheel 12. The connecting member 64 may be connected to the tube portion 54 of the wheel hub 18.

The drive device 10 is connected to the connecting member 64 and the vehicle wheel 12 via the first joint device 46. The connecting points between the joint device 46 and the connecting member 64 have a predetermined radial distance from the wheel hub 18. The joint device 44 may be connected to the connecting member 64 via screws 66. The joint device 48 is further connected to the flange portion 50 of the hollow shaft 44 via screws 68. The flange portion 52 of the hollow shaft 44 is connected to the second joint device 48 via screws 70. The second joint device 48 is connected to the carrier member 42 of the planetary gear 24 via screws 72.

The hollow shaft 44 radially surrounds at least the electric motor 22. In other words, the hollow shaft 44 extends radially around the outside of at least the electric motor. When the drive device 10 is at rest, the electric motor 22 and the hollow shaft 44 are arranged coaxially. The tube portion 54 and the axle portion 60 may extend radially within the electric motor 22. The electric motor 22 may at least partially surround the tube portion 54 and the axle portion 60.

The drive device 10 extends in an axial direction entirely between the connecting member 64 and the vehicle body or the vehicle frame 32. The drive device 10 is connected to the side of the connecting member 64 facing away from the rim 16. The drive device 10 is mostly accommodated in the rim 16 and thus arranged close to the wheel.

The drive device 10 is firmly attached to the vehicle body or the vehicle frame 32. The drive device 10 is attached to the vehicle body or the vehicle frame 32 independently of the axle 62. As can be seen in FIG. 1, the drive unit formed by the electric motor 22 and the transmission 24 is fastened to the vehicle body or the vehicle frame 32 independently of the rigid axle 62. Furthermore, the drive unit formed by the electric motor 22 and the transmission 24 is connected to the vehicle wheel 12 independently of the wheel hub 18.

The torque transmission device 20 of the drive device 10 establishes a torque-transmitting connection between the drive unit, formed by the electric motor 22 and the transmission 24, and the vehicle wheel 12 via the first joint device 46, the hollow shaft 44 and the second joint device 48. The drive unit formed by the electric motor 22 and the transmission 24 is decoupled from the vehicle wheel 12 by the torque transmission device 20 comprising the first joint device 46, the hollow shaft 44 and the second joint device 48. Relative movements between the vehicle wheel 12 and the drive unit formed by the electric motor 22 and the transmission 24 and attached to the vehicle body or the vehicle frame 32 can be compensated via the torque transmission device 20. In this way, the unsprung masses on the vehicle wheel 12 can be reduced significantly.

In the following description of further embodiments, the same reference signs as in the first embodiment described above are used for elements and features that are similar and have the same effect.

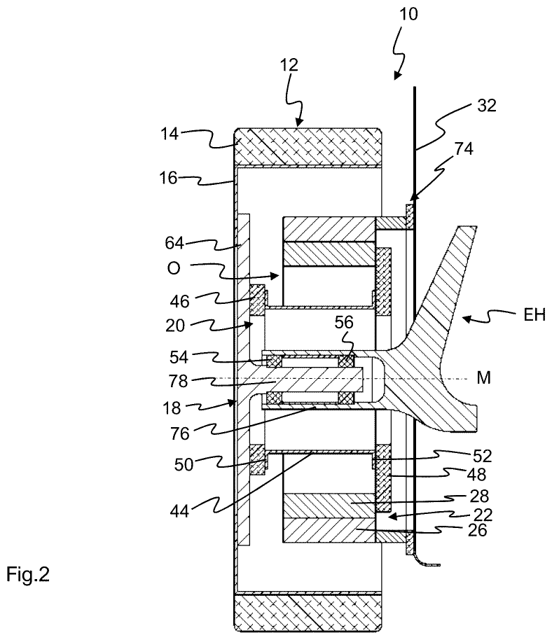

FIG. 2 is a schematic sectional view of another embodiment of the drive device 10. The drive device 10 has a torque transmission device 20 and an electric motor. The electric motor 22 has a stator 26 and a rotor 28. The drive device 10 according to this embodiment may be designed without a transmission and form a gearless direct drive. The electric motor 22 of the drive device 10 is connected to the vehicle body or the vehicle frame 32 via a fastening device 74. The fastening device 74 may act as a torque support and have elastic elements.

The electric motor 22 is coupled to the vehicle wheel via the torque transmission device 20 in a torque-transmitting manner. The torque transmission device 20 comprises the first joint device 46, the hollow shaft 44 and the second joint device 48. The first joint device 46 is connected to a connecting member 64 connected to the wheel hub 18. The second joint device 48 is connected to the rotor 28 of the electric motor 22. Starting from the rotor 28, the second joint device 48 extends radially inwards towards the hollow shaft 44. The second joint device 48 is connected to the flange portion 52 of the hollow shaft 44. Starting from the second joint device 48, the hollow shaft 44 extends in an axial direction to the first joint device 46 which is connected to the hollow shaft 44 via its flange portion 50. The first joint device 46 is connected to the connecting member 64.

The hollow shaft 44 extends through the electric motor 22. For this purpose, the electric motor 22 has an opening O. The electric motor 22 thus radially surrounds the hollow shaft 44. The electric motor 22 and the hollow shaft 44 are arranged coaxially. The electric motor 22 and the hollow shaft 44 are arranged coaxially with the axis of rotation M of the vehicle wheel 12.

According to this embodiment, the vehicle (not shown) has an independent wheel suspension EH to which the vehicle wheel 12 is attached. A tubular receptacle 76 is configured on the independent wheel suspension EH, in which the wheel bearings 54 and 56 are accommodated. An axle portion 78 configured on the connecting member 64 is rotatably mounted on the independent wheel suspension EH via the wheel bearings 54 and 56. In the schematic representation shown in FIG. 2, the rim 16 is attached to the connecting member 64. According to this embodiment, the tubular receptacle 76 and the axle portion 78 form the wheel hub 18.

In this embodiment, too, the drive device 10 is arranged in an axial direction entirely between the rim 16, i.e., the side of the rim 16 facing the vehicle body or the vehicle frame 32, and the vehicle body or the vehicle frame 32. The electric motor 22 as well as the torque transmission device 20 formed by the first joint device 46, the hollow shaft 44 and the second joint device 48 are arranged in an axial direction mostly within the rim 16 and within the vehicle wheel 12, respectively.

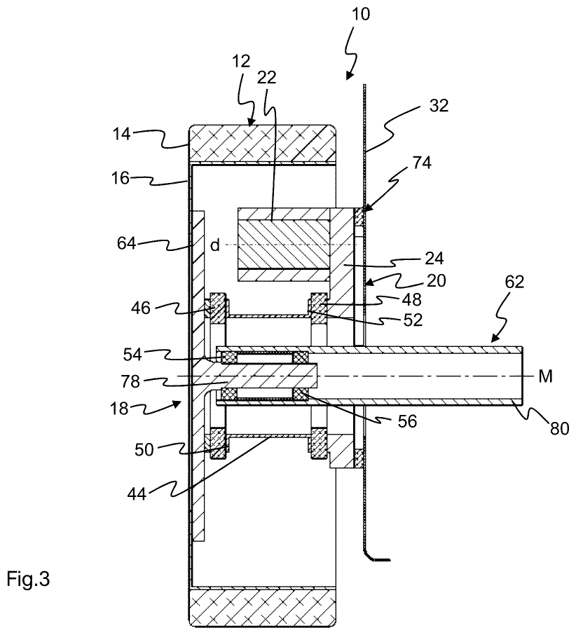

FIG. 3 is a schematic sectional view of another embodiment of the drive device 10. The drive device 10 comprises the torque transmission device 20, the electric motor 22 and the transmission 24. The torque transmission device 20 comprises the first joint device 46, the hollow shaft 44 and the second joint device 48. The transmission 24 may be configured as a spur gear. The transmission 24 extends from the motor 22 to the second joint device 48 to which the transmission 24 is coupled. The second joint device 48 is connected to the connecting member 64 on the rim 16 via the hollow shaft 44 and the first joint device 46. A tubular portion 80 of an axle 62 of the vehicle is visible radially within the hollow shaft 44. The portion 80 of the axle 64 and the axle portion 78 on the connecting member 64 form the wheel hub 18. The hollow shaft 44 thus radially surrounds the wheel hub 18.

The electric motor 22 is arranged with an offset from the hollow shaft 44. The axis of rotation d of the electric motor 22 is arranged in a radial direction with an offset from the axis of rotation M of the vehicle wheel 12. Accordingly, the axis of rotation d of the electric motor 22 is arranged with an offset from the central axis of the hollow shaft 44 also in a radial direction. In FIG. 3, the electric motor 22 is arranged above the hollow shaft 44.

The transmission 24 extends between the electric motor 22 and the vehicle body or vehicle frame 32 to the second joint device 48. The torque transmission device couples the drive unit formed by the electric motor 22 and the transmission 24 to the vehicle wheel 12 in a torque-transmitting manner. At the same time, the drive unit formed by the electric motor 22 and the transmission 24 is decoupled from the vehicle wheel 12 in terms of suspension via the torque transmission device 20. The drive unit formed by the electric motor 22 and the transmission 24 is attached to the vehicle body or vehicle frame 32 via the fastening device 74. The fastening device 74 is arranged on the transmission 24 or a housing of the transmission 24.

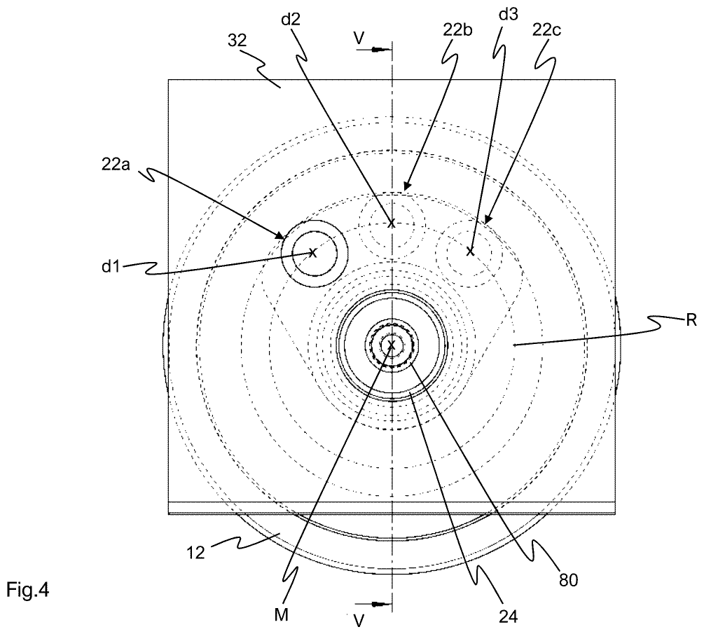

FIG. 4 is a schematic rear view of a drive device 10, taken from the direction of the vehicle body or vehicle frame 32. According to this embodiment, the drive device 10 has three electric motors 22a, 22b, 22c. The electric motors 22a, 22b, 22c may be coupled to the transmission 24. For example, the electric motors 22a, 22b, 22c may each be individually coupled to a pinion or gear wheel of the transmission 24. The electric motors 22a, 22b, 22c are arranged around the axis of rotation M of the vehicle wheel 12 with an offset from one another by predetermined angular amounts. The axes of rotation d1, d2, d3 of the electric motors 22a, 22b, 22c may be arranged on a common radius R around the axis of rotation M of the vehicle wheel 12.

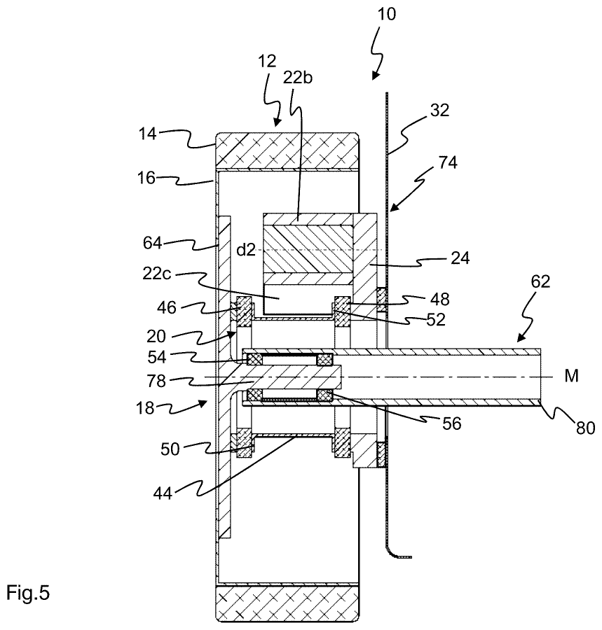

FIG. 5 is a sectional view taken along section line V-V in FIG. 4. The design of the torque transmission device 20 comprising the hollow shaft 44, the first joint device 46 and the second joint device 48 corresponds to the design of the torque transmission device 20 of the embodiment shown in FIG. 3. According to this embodiment, the drive device 10 comprises the three electric motors 22a, 22b, 22c, as can already be seen in FIG. 4. Of these three electric motors, electric motor 22b and electric motor 22c are shown in the sectional view in FIG. 5. The electric motors 22a, 22b, 22c are coupled to the transmission 24 extending between the electric motors 22a, 22b, 22c and the body 32. The transmission 24 may, for example, have different pinion gears, one of which is assigned to each of the electric motors 22a, 22b, 22c. Even if the embodiment of FIGS. 4 and 5 provides for three electric motors 22a, 22b, 22c, 2, 4, 5 or more electric motors may be arranged.

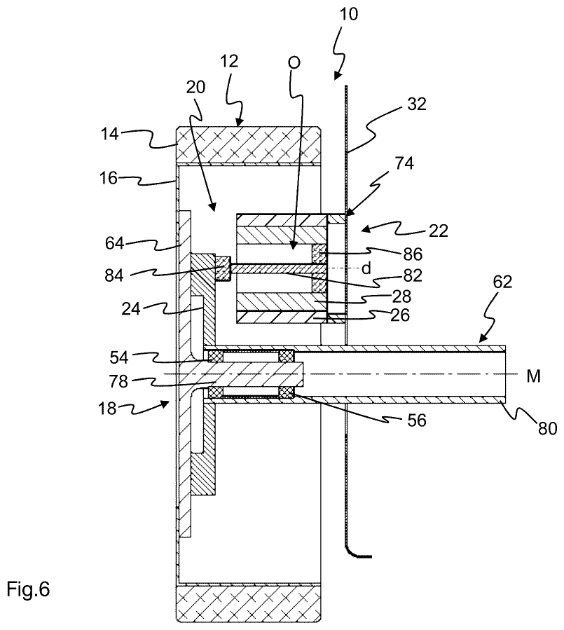

FIG. 6 is a schematic sectional view of a drive device 10 according to another embodiment. The electric motor 22 has a stator 26 and a rotor 28. The electric motor 22 is firmly or elastically attached to the vehicle body or the vehicle frame 32 via the fastening device 74. The electric motor 22 is arranged in a radial direction with an offset from the axis of rotation M of the vehicle wheel 12, i.e., the axis of rotation d of the electric motor 22 is offset in a radial direction from the axis of rotation M of the vehicle wheel 12. The transmission 24 is coupled to the connecting member 64 to be able to drive the vehicle wheel 12.

The drive device 10 comprises the torque transmission device 20 comprising a first joint device 84, a shaft 82 and a second joint device 86. The shaft 82 extends in the electric motor 22 at least in sections. In the schematic representation according to FIG. 6, the second joint device 86 is arranged within the electric motor 22 and is connected to one end of the shaft 82. However, the second joint device 86 may also be arranged along the axis of rotation d to the right of and coupled to the electric motor 22. In other words, the second joint device 86 may be positioned outside the electric motor 22 in an axial direction. In this case, only the shaft 82 extends through the electric motor 22 between the two joint devices 84 and 86 arranged outside the electric motor 22 in an axial direction. The shaft 82 is coupled to the transmission 24 via the first joint device 84 and to the electric motor 22 via the second joint device 86. The first joint device 84 is arranged between the transmission 24 and the shaft 82. The second joint device 86 is arranged between the shaft 82 and the electric motor 22. The transmission 24 is coupled to the connecting member 64 on the vehicle wheel 12 and is supported on the tube portion 80 of the axle 64 of the vehicle. The electric motor 22 drives the transmission 24 via the second joint device 86, the shaft 82 and the first joint device 84. The transmission 24 transmits the torque generated by the electric motor 22 to the vehicle wheel 12.

The torque transmission device 20 thus extends between the electric motor 22 and the transmission 24 arranged on the vehicle wheel 12. The torque transmission device 20 thus decouples the electric motor 22 from the transmission 24 arranged on the vehicle wheel 12 and the vehicle wheel in terms of suspension.

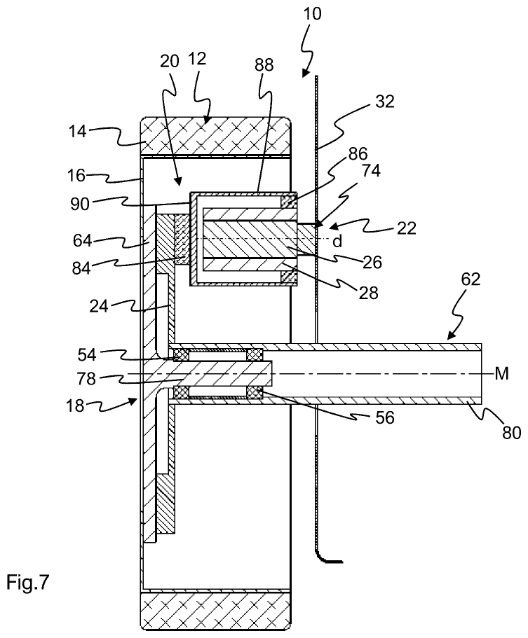

FIG. 7 is a schematic sectional view of a drive device 10 according to another embodiment. Similar to the embodiment described with reference to FIG. 6, the transmission 24 is coupled to the connecting member 64 on the vehicle wheel 12. The torque transmission device 20 comprises a first joint device 84, a hollow shaft 88 and a second joint device 86. The first joint device 84, the hollow shaft 88 and the second joint device 86 are arranged between the transmission 24 and the electric motor 22. The hollow shaft 88 according to this embodiment comprises a base 90 that is coupled to the first joint device 84. The electric motor 22 as well as the second joint device 86 are accommodated in the hollow shaft 88 at least in sections. The electric motor 22 according to this embodiment is configured as an external rotor motor. The radially outer rotor 28 of the electric motor 22 drives the transmission 24, which drives the vehicle wheel 12, via the second joint device 86, the hollow shaft 88 and the first joint device 84. In this embodiment, too, the second joint device 86 may be arranged to the right of the electric motor 22 in the direction of the axis of rotation d in order to couple the electric motor 22 to the hollow shaft 88.

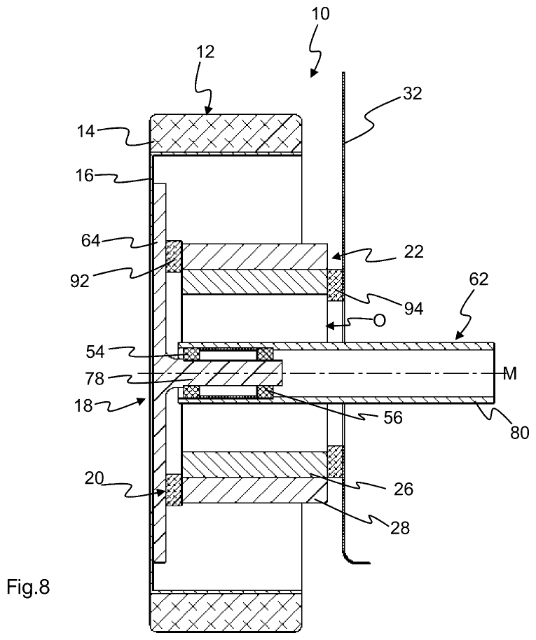

FIG. 8 is a schematic sectional view of a drive device 10 according to another embodiment. According to this embodiment, the drive device 10 is configured as a gearless direct drive. The drive device 10 comprises the torque transmission device 20 and the electric motor 22. According to this embodiment, the torque transmission device 20 comprises a joint device 92. The electric motor 22 has a stator 26 and a rotor 28. The rotor 28 is located radially outside the stator 26. The electric motor 22 is configured as an external rotor motor.

The electric motor 22 is directly or firmly or elastically coupled to the vehicle body or the vehicle frame 32 via a fastening device 74. The fastening device 74 may be configured as a torque support. The fastening device 74 may have at least one elastic element to decouple the electric motor 22 from the vehicle body or the vehicle frame 32, in particular acoustically or in terms of vibration.

The electric motor 22 is directly coupled to the vehicle wheel 12 via the first joint device 92, i.e., no transmission is provided. The drive device 10 according to this embodiment thus represents a gearless direct drive for the vehicle wheel 12. The electric motor 22 has an opening O through which the tube portion 80 of the axle 64 and the axle portion 78 can extend at least partially. The tube portion 80 and the axle portion 78 may at least partially also extend through the first joint device 92 axially. When the vehicle wheel 12 is at rest, the electric motor 22 and the joint device 94 are arranged coaxially with the tube portion 80 of the axle 64 as well as the axle portion 78.

The gearless direct drive is achieved with the direct and gearless coupling of the rotor 28 of the electric motor 22 to the connecting member 64 on the rim 16 of the vehicle wheel 12 via the joint device 92. Relative movements between the electric motor 22 and the vehicle wheel 12 can be compensated via the joint device 92. The electric motor 22 can be decoupled from the vehicle wheel 12 in terms of suspension via the joint device 92.

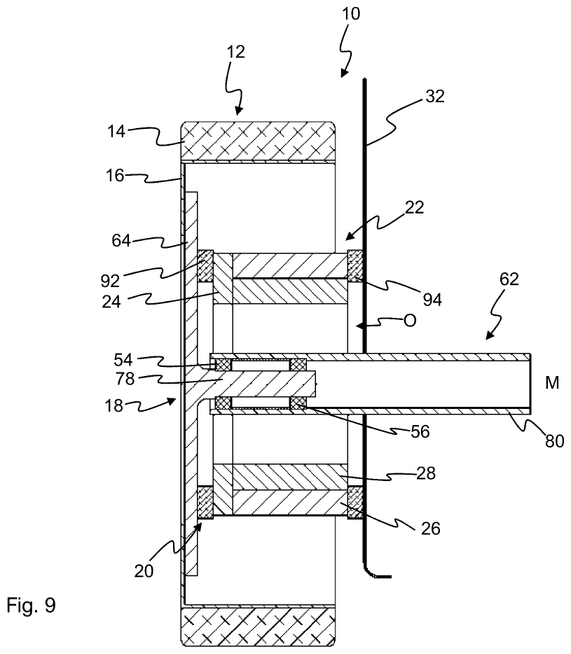

FIG. 9 is a schematic sectional view of a drive device 10 according to another embodiment. The embodiment shown in FIG. 9 largely corresponds to the embodiment described with reference to FIG. 8.

The drive device 10 comprises a transmission 24. The transmission 24 is arranged in an axial direction between the electric motor 22 and the joint device 92. The joint device 92 couples the transmission 24 to the connecting member 64 and thus to the vehicle wheel 12. The electric motor 22 and the transmission 24 have an opening O through which the axle portion 78 and the tube portion 80 of the axle 64 can extend at least partially. The electric motor 22 is configured as an internal rotor motor, i.e. the rotor 28 is located radially within the stator 26. The rotor 28 drives the transmission 24 to drive the vehicle wheel 12 via the first joint device 92.

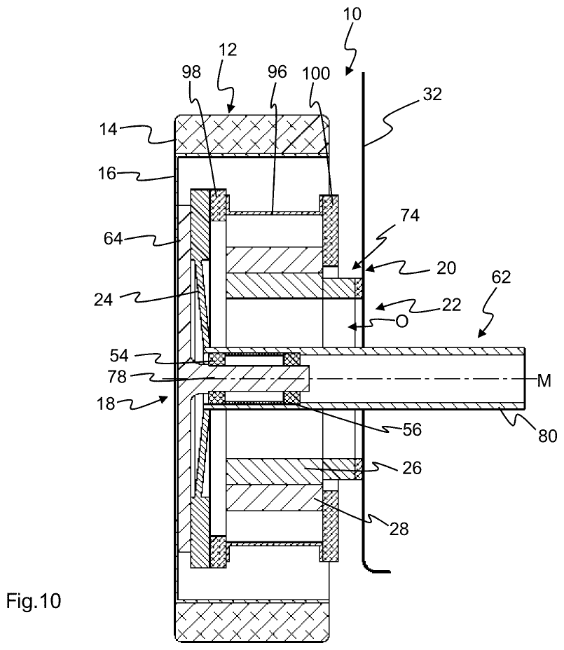

FIG. 10 is a schematic sectional view of a drive device 10 according to another embodiment. The drive device 10 comprises a torque transmission device 20 comprising a first joint device 98, a hollow shaft 96 and a second joint device 100. The torque transmission device 20 couples the electric motor 22 to the transmission 24 on the vehicle wheel 12. The electric motor 22 is coupled to the transmission 24 in a torque-transmitting manner via the hollow shaft 96, the first joint device 98 and the second joint device 100. The electric motor 22 is configured as an external rotor motor, i.e. the rotor 28 is arranged radially on the outside. The electric motor 22 is attached to the vehicle body or the vehicle frame 32 via the fastening device 74. The electric motor 22 has an opening O through which the axle portion 78 and the tube portion 80 of the axle 62 extend at least partially.

The electric motor 22 is arranged radially within the hollow shaft 96. The electric motor 22 is coupled to the hollow shaft 96 via the second joint device 100. The second joint device 100 extends outwards in a radial direction towards the hollow shaft 96. The hollow shaft 96 is coupled to the transmission 24 via the first joint device 98. This means that with its side facing the vehicle body or the vehicle frame 32, the electric motor 22 is coupled to the second joint device 100 extending outwards in a radial direction towards the hollow shaft 96.

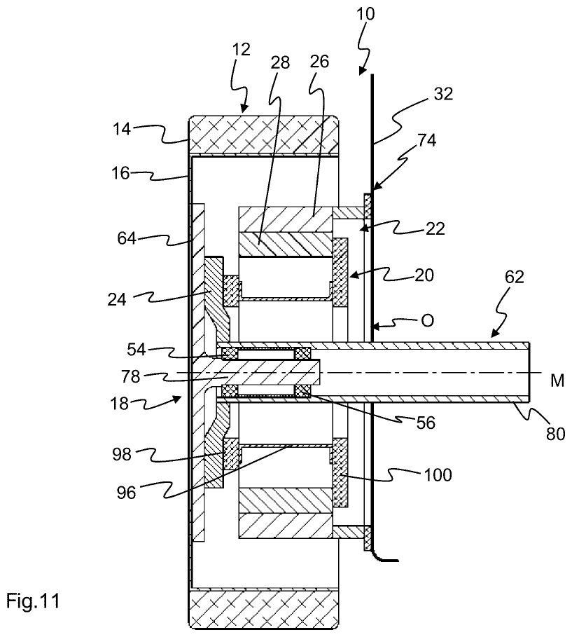

FIG. 11 is a schematic sectional view of a drive device 10 according to another embodiment. The torque transmission device 20 has a hollow shaft 96, a first joint device 98 and a second joint device 100. The electric motor 22 is attached to the vehicle body or vehicle frame 32 via the fastening device 74.

The hollow shaft 96 extends in the opening O of the electric motor 22, i.e. radially within the electric motor 22. The electric motor 22 is configured as an internal rotor motor, i.e. the rotor 28 is located radially within the stator 26. The rotor 28 is connected to the hollow shaft 96 via the second joint device 100. Starting from the rotor 28, the second joint device 100 extends inwards in a radial direction towards the hollow shaft 96. The second joint device 100 extends on the side of the electric motor 22 facing the vehicle body or vehicle frame 32. The first joint device 98 couples the other end of the hollow shaft 96 to the transmission 24. The transmission 24 is arranged on the connecting member 64, is supported on the tubular portion 80 and drives the vehicle wheel 12.

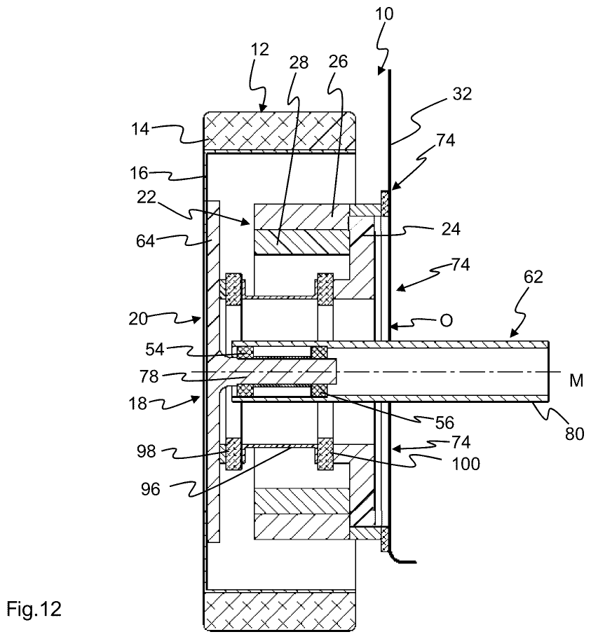

FIG. 12 is a schematic sectional view of a drive device 10 according to another embodiment. The torque transmission device 20 comprises the first joint device 98, the hollow shaft 96 and the second joint device 100 that is coupled to the transmission 24. The electric motor 22 and the transmission 24 form a drive unit. The transmission 24 extends between the electric motor 22 and the hollow shaft 96 which is arranged within the opening O of the electric motor 22. The transmission 24 extends radially inwards from the electric motor 22 and is connected to the second joint device 100 of the torque transmission device 20. The torque transmission device 20 couples the drive unit formed by the electric motor 22 and the transmission 24 to the vehicle wheel 12 in a torque-transmitting manner while additionally ensuring that this drive unit decouples from the vehicle wheel 12 in terms of suspension.

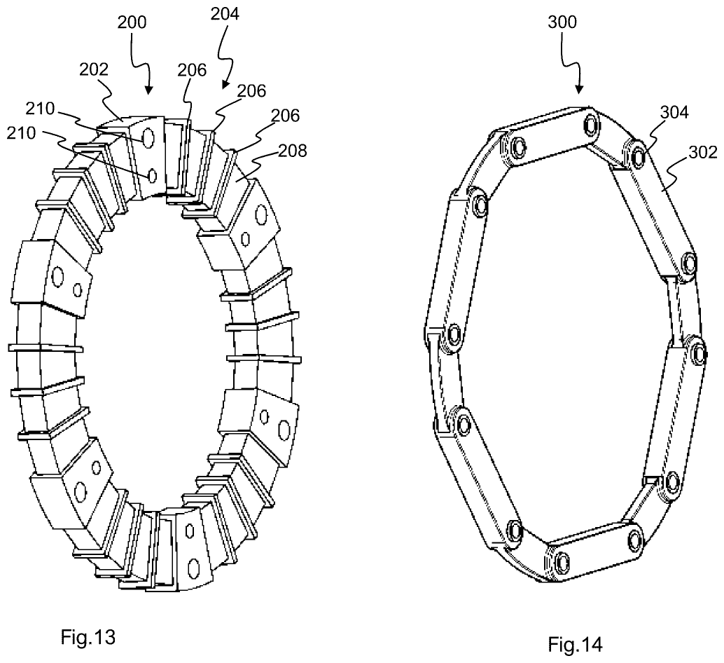

FIG. 13 is a perspective view of an elastic joint device according to one implementation. The elastic joint device can be used as a first joint device and/or as a second joint device. It is a wedge package coupling 200. The wedge package coupling 200 has a plurality of wedge-shaped elements 202 connected to one another via metal-elastomer packages 204. Each of the metal-elastomer packages 204 has a plurality of metal elements 206 connected to one another via elastomeric portions 208. Some of the elastomeric portions 208 are connected to the wedge-shaped elements 202. Openings 210 are configured in the wedge-shaped elements 202 which may serve to connect the wedge package coupling 200, for example, to the hollow shaft or other components of the drive device 10.

FIG. 14 is a perspective view of an elastic joint device according to another implementation. The elastic joint device can be used as a first joint device and/or as a second joint device. This exemplary joint device 300 is a ring of tabs. The ring of tabs 300 has an elastic body 302, bushings 304 and thread packages (not shown) coupling at least two of the bushings 304 to one another. The thread packages (not shown) are embedded into the elastic body 302. Screws or similar fasteners can be guided through the bushings 304 to be able to connect the ring of tabs 300, for example, to the hollow shaft and/or the drive unit of the embodiments described above.

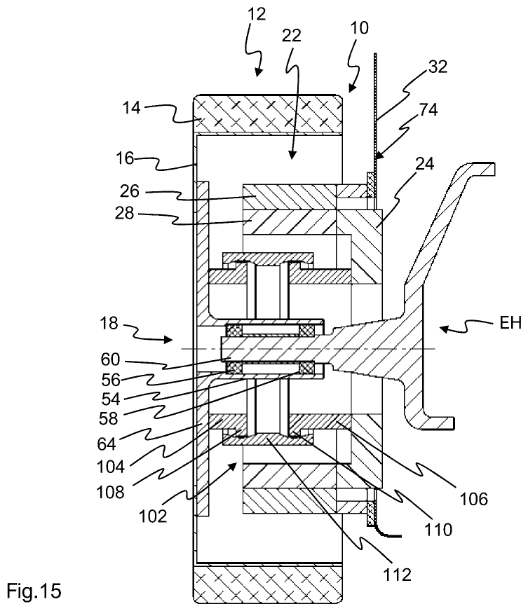

FIG. 15 is a sectional view of a drive device 10 according to another embodiment. According to this embodiment, the vehicle (not shown) has an independent wheel suspension EH to which the vehicle wheel 12 is attached. An axle portion 60 is configured on the independent wheel suspension EH. The wheel hub 18 has a tube portion 54 accommodating the wheel bearings 56 and 58. The wheel hub 18 is rotatably mounted on the axle portion 60 via the wheel bearings 56 and 58.

The torque transmission device 20 comprises the joint device 102. The torque transmission device 20 couples the electric motor 22 to the vehicle wheel 12. The electric motor 22 is attached to the vehicle body or the vehicle frame 32 via the fastening device 74. The transmission 24 extends between the electric motor 22 and a joint device 102. The joint device 102 comprises two toothed portions 104 and 106. The toothed portions 104 and 106 each have a row of teeth 108 and 110 that is directed radially outwards. The two toothed portions 104 and 106 are connected to one another through a connecting portion 112 having curved guide tracks for the rows of teeth 108 and 110 on its radially inner side. According to this embodiment, the joint device 102 is configured as a curved-tooth coupling.

With the torque transmission device 20 of the drive device 10, at least the electric motor 22 or the drive unit formed by the electric motor 22 and the transmission 24 can be decoupled from the vehicle wheel 12 in terms of suspension. This helps to reduce the unsprung masses on the vehicle wheel 12. In addition, the drive device 10 has a simple design requiring little installation space.

Various embodiments have been described in detail above with reference to the accompanying figures. The embodiments shown are structured in such a way that various parts or components, such as the arrangement of the drive and the transmission, the design of the motor (internal/external rotor), and the various axle/suspension variants (portal axle, rigid axle, independent wheel suspension, etc.) of the embodiments described can be combined to form embodiments not shown.

1. A drive device for a vehicle wheel, wherein the drive device is configured to be fastened to a vehicle body or a vehicle frame close to the wheel, wherein the drive device has at least one drive and at least one torque transmission device, wherein the torque transmission device is configured to decouple the at least one drive from the at least one vehicle wheel, wherein the at least one torque transmission device has at least one joint device.

2. The drive device of claim 1, wherein the torque transmission device has at least one shaft coupled to the at least one joint device.

3. The drive device of claim 2, wherein the torque transmission device has at least one first joint device and at least one second joint device that are coupled to the at least one shaft.

4. The drive device of claim 1, wherein the at least one drive is arranged coaxially with the axis of rotation of the vehicle wheel.

5. The drive device of claim 2, wherein the at least one shaft is a hollow shaft.

6. The drive device of claim 2, wherein the at least one drive is arranged coaxially with the at least one shaft.

7. The drive device of claim 1, wherein the at least one drive is arranged in a radial direction with an offset from the axis of rotation of the vehicle wheel.

8. The drive device of claim 1, wherein the drive device comprises a plurality of drives that are arranged in a radial direction with an offset from the axis of rotation of the vehicle wheel.

9. The drive device of claim 1, wherein the axis of rotation of the drive extends substantially parallel to the axis of rotation of the vehicle wheel.

10. The drive device of claim 1, wherein the drive device has at least one transmission.

11. The drive device of claim 10, wherein the drive is coupled to the at least one transmission via the at least one shaft and the at least one joint device.

12. The drive device of claim 10, wherein the at least one transmission is arranged on the at least one drive.

13. The drive device of claim 10, wherein the at least one transmission, at least in sections, is arranged in an axial direction with an offset from the at least one drive.

14. The drive device of claim 1, wherein the at least one joint device couples the at least one drive to the vehicle wheel directly and without a transmission in a torque-transmitting manner.

15. The drive device of claim 1, wherein the at least one drive is attached directly to the vehicle body or the vehicle frame via an elastic fastening device.

16. The drive device of claim 5, wherein the at least one hollow shaft comprises two flange portions, wherein the first joint device and the second joint device are arranged on the axial outer surfaces of the flange portions.

17. The drive device of claim 5, wherein the hollow shaft extends radially around the outside of the drive or through the drive.

18. The drive device of claim 1, wherein the at least one joint device is configured as a thread-reinforced joint device.

19. The drive device of claim 18, wherein the at least one joint device comprises at least one thread package, at least two bushings and at least one elastic body into which the at least one thread package is embedded.

20. The drive device of claim 1, wherein the at least on joint device is configured as a wedge package coupling or as a curved-tooth coupling.

21. The drive device of claim 1, wherein the at least one torque transmission device is configured such that the at least one torque transmission device is arranged between the at least one drive and the at least one transmission or between the at least one drive and the vehicle wheel.

22. The drive device of claim 10, wherein the torque transmission device is arranged between the at least one drive and the vehicle wheel.

23. The drive device for a vehicle wheel, wherein the drive device is configured to be fastened to a vehicle body or vehicle frame close to the wheel, wherein the drive device has at least one drive and at least one joint device, wherein the at least one joint device is configured to directly couple the at least one drive to the at least one vehicle wheel.

24. The drive device of claim 1, wherein the at least one drive is an electric motor.

25. The drive device of claim 23, wherein the at least one drive is an electric motor.

26. The drive device of claim 1, wherein the vehicle wheel is a wheel of an electric road vehicle.

27. The drive device of claim 23, wherein the vehicle wheel is a wheel of an electric road vehicle.

28. A vehicle axle or independent wheel suspension for an electric vehicle, comprising a drive device of claim 1.

29. A vehicle axle or independent wheel suspension for an electric vehicle, comprising a drive device of claim 23.

30. An electric road vehicle, comprising at least one drive device of claim 1.

31. An electric road vehicle, comprising at least one drive device of claim 23.
